(19) United States
(12) Patent Application Publication
(10) Pub. No.: US 2022/0013758 A1
(43) Pub. Date: Jan. 13, 2022

(54) VEHICULAR BATTERY PACK AND VEHICLE INCLUDING THE SAME

(71) Applicants: HYUNDAI MOTOR COMPANY, Seoul (KR); KIA MOTORS CORPORATION, Seoul (KR)

(72) Inventor: Hyun Chang KANG, Seoul (KR)

(73) Assignees: HYUNDAI MOTOR COMPANY, Seoul (KR); KIA MOTORS CORPORATION, Seoul (KR)

(21) Appl. No.: 17/096,038

(22) Filed: Nov. 12, 2020

(30) Foreign Application Priority Data
Jul. 10, 2020 (KR) 10-2020-0085393

(51) Int. Cl. H01M 2/12; H01M 10/04

(52) U.S. Cl. CPC H01M 2/1252; H01M 2220/20; H01M 10/0413

(57) ABSTRACT

A vehicular battery pack includes: a case having an internal space to accommodate a battery cell therein, an inlet to introduce air into the internal space of the case, an outlet to discharge air from the internal space of the case, and an expandable foam member disposed in at least a portion of each of the inlet and the outlet.

### CROSS-REFERENCE TO THE RELATED APPLICATION

This application claims priority to and the benefit of Korean Patent Application No. 10-2020-0085393, filed on Jul. 10, 2020, the entire contents of which are incorporated herein by reference.

### FIELD

The present disclosure relates to a vehicular battery pack and a vehicle including the same.

### BACKGROUND

The statements in this section merely provide background information related to the present disclosure and may not constitute prior art.

Eco-friendly vehicles, such as hybrid vehicles and electric vehicles, are equipped with a battery configured to store electrical energy for driving a motor that generates power.

In recent years, as various types of vehicles, such as general automobiles, sports utility vehicles (SUVs), multi-purpose vehicles (MPVs), and small trucks, have been electrified, various layouts have been developed to provide space for installation of a battery in an electric vehicle.

In particular, since a battery generates high-temperature heat when a battery cell provided therein is charged or discharged, it is required to form a battery installation structure capable of easily dissipating the heat generated from the battery while securing sufficient space for accommodating occupants or loading cargo in the vehicle.

As one exemplary battery installation structure, there is known an air-cooled battery installation structure in which a battery is disposed below a second-row seat in the vehicle and cooling air for cooling the battery is supplied from the interior of the vehicle and is discharged to the outside of the vehicle.

This conventional air-cooled battery installation structure is mainly applied to SUVs, in which a seating position is relatively high, and is advantageous in that the space below the second-row seat is utilized. However, we have discovered that since cooling air is supplied from the interior of the vehicle having the conventional battery installation structure, a cooling air intake is exposed to the interior of the vehicle. When a fire occurs due to thermal runaway in a battery cell inside the battery for various reasons, flames or harmful gases may enter the interior of the vehicle through the cooling air intake, which may be harmful or fatal to occupants.

The information disclosed in this Background section is only for enhancement of understanding of the general background of the present disclosure and should not be taken as an acknowledgement or any form of suggestion that this information forms the related art already known to a person skilled in the art.

### SUMMARY

The present disclosure provides a vehicular battery pack capable of minimizing or inhibiting the occurrence of a fire and delaying combustion by blocking air from entering the battery pack when thermal runaway occurs in a battery cell inside the battery pack, and a vehicle including the battery pack.

In accordance with an aspect of the present disclosure, a vehicular battery pack includes: a case having an internal space to accommodate a battery cell therein, an inlet configured to introduce air into the internal space of the case, an outlet configured to discharge air from the internal space, and an expandable foam member disposed in at least a portion of each of the inlet and the outlet. When the temperature of the internal space becomes equal to or higher than a preset temperature, the expandable foam member expands to interrupt introduction of air through at least a portion of each of the inlet and the outlet.

In one form of the present disclosure, the inlet may be implemented in the form of a duct that is open in a direction for introducing air.

In another form of the present disclosure, the duct may be disposed so as to introduce air from the interior of the vehicle.

In some forms of the present disclosure, the outlet may be implemented in the form of a connection pipe connecting the internal space to a component provided outside the case.

In some forms of the present disclosure, the vehicular battery pack may further include a fan connected to the outlet to suction air from the outlet.

In some forms of the present disclosure, the fan may discharge the suctioned air to an air discharge structure connected to another ventilation structure of the vehicle.

In accordance with another form of the present disclosure, a vehicle includes: a battery pack installed below a seat provided in the interior of the vehicle, the battery pack including a case having an internal space to accommodate a battery cell therein, an inlet configured to introduce air into the internal space of the case, an outlet configured to discharge air from the internal space of the case, and an expandable foam member disposed in at least a portion of each of the inlet and the outlet. The inlet introduces air from the interior of the vehicle to the internal space of the case, and the air discharged through the outlet flows along a side surface of the vehicle through another structure of the vehicle and is discharged to the outside of the vehicle.

In one form of the present disclosure, the inlet may be implemented in the form of a duct that is open toward the interior of the vehicle so as to introduce air from the interior of the vehicle to the internal space of the case.

In another form of the present disclosure, the duct may be open in a direction oriented toward the legs of an occupant sitting on the seat.

In one form of the present disclosure, the battery pack may further include a fan connected to the outlet and configured to suction air from the outlet.

In some forms of the present disclosure, the vehicle may further include: an interior material disposed on the side surface of the vehicle and an extractor grill disposed at a rear-lateral portion of the body of the vehicle, and the air discharged from the outlet may be delivered to the extractor grill through the space between the interior material and the body of the vehicle and may be discharged to the outside of the vehicle.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a vehicular battery pack according to one form of the present disclosure;

FIG. 2 is a cross-sectional view taken along line A-A′ in the battery pack shown in FIG. 1;

FIG. 3 is an enlarged cross-sectional view of an inlet of the vehicular battery pack shown in FIG. 2;

FIG. 4 is an enlarged cross-sectional view of an outlet of the vehicular battery pack shown in FIG. 2; and

FIG. 5 is a perspective view of the structure in which the vehicular battery pack in one form of the present disclosure is installed in a vehicle.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, a vehicular battery pack according to exemplary forms of the present disclosure will be described with reference to the accompanying drawings.

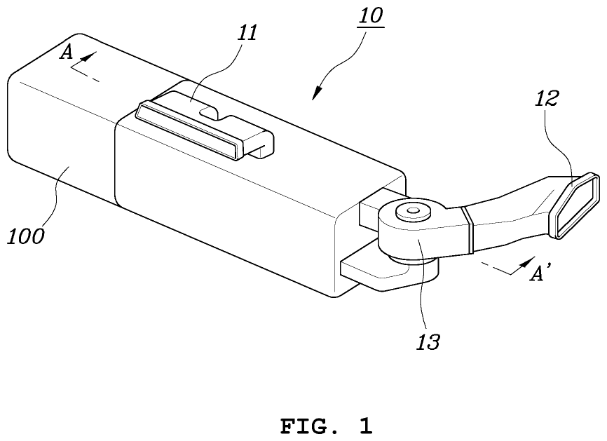

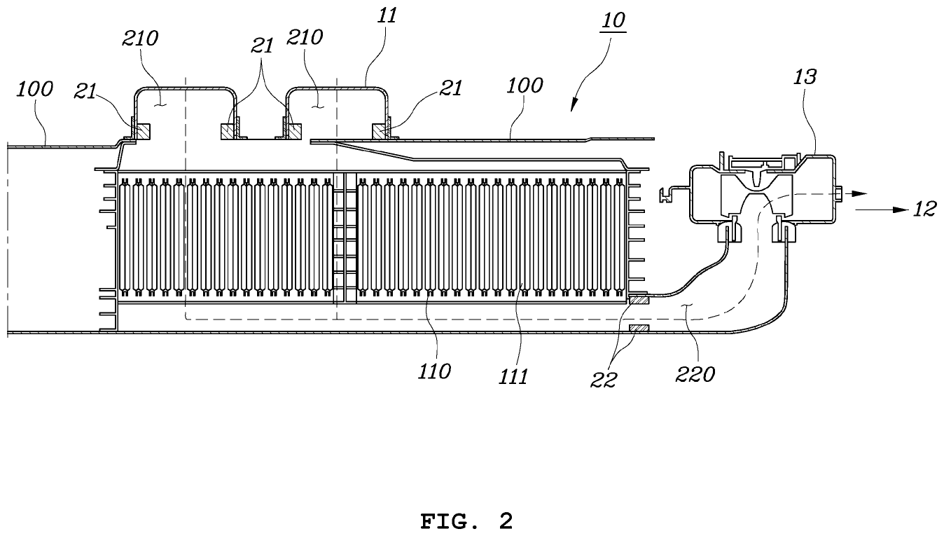

FIG. 1 is a perspective view of a vehicular battery pack according to one form of the present disclosure, and FIG. 2 is a cross-sectional view taken along line A-A′ in the battery pack shown in FIG. 1.

Referring to FIGS. 1 and 2, the vehicular battery pack 10 may include: a case 100 having therein a space for accommodating a battery cell 111, an inlet 210 through which air is introduced into the case 100 to cool the battery cell 111, an outlet 220 through which the air used to cool the battery cell 111 is discharged to the outside of the case 100, and expandable foam members 21 and 22 disposed in at least a portion of each of the inlet 210 and the outlet 220.

The case 100 may have therein an internal space for accommodating the battery cell 111, which is a unit structure storing electrical energy.

Not only the battery cell 111 but also electric components, such as a relay configured to allow or interrupt electrical connection between a battery module 110 including the battery cell 111 and an external device and an auxiliary battery configured to supply electrical power to electronic components of the vehicle, may be accommodated in the case 100. The battery module 110 may be installed in a space that is isolated from other electric components inside the case 100.

The battery cell 111, which is a unit structure storing electrical energy, may be disposed in the form of a module 110.

One battery module 110 may include a plurality of battery cells 111 electrically connected to each other. The plurality of battery cells 111 included in one battery module 110 may be arranged in a preset arrangement. Particularly, in the case of an air-cooled battery that is cooled by means of air, the battery cells 111 may be arranged such that air passes between the battery cells 111.

A plurality of battery modules 110 may be installed in the accommodation space in the case 100 of the battery pack 10.

The inlet 210, which is a part for introducing cooling air into the case 100 from outside the case 100, may be formed in the case 100. As shown in FIGS. 1 and 2, the inlet 210 may be implemented in the form of a duct 11, which is open in a direction for introducing air. External air introduced into the duct 11 may enter the space in the case 100, in which the battery cells 111 are disposed, through a through-hole formed in the case 100.

The outlet 220, which is a part for discharging the air in the case 100 to the outside of the case 100, may be formed so as to be connected to a through-hole formed in the case 100. As shown in FIG. 2, the outlet 220 may be implemented in the form of a connection pipe connecting the through-hole formed in the case 100 to a fan 13.

As indicated by the dotted arrow in FIG. 2, the air introduced into the space in the case 100, in which the battery cells 111 are disposed, through the inlet 210 may pass through the space between the battery cells 111 and may be discharged to the outside of the case 100 through the outlet 220. The outlet 220 may be connected to the fan 13 for forming an air flow.

The fan 13 may be driven so as to suction air from the outlet 220 of the case 100 of the battery pack 10 and to discharge the air to an air discharge structure 12, which is connected to another ventilation structure of the vehicle.

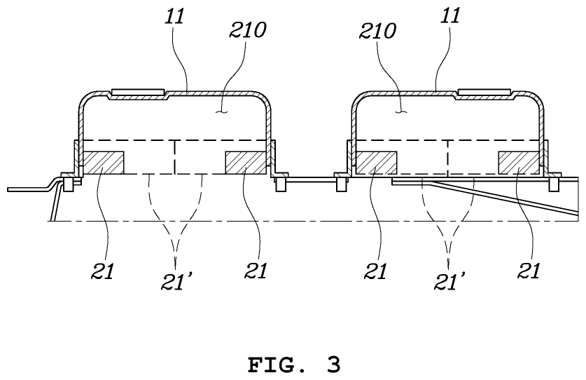

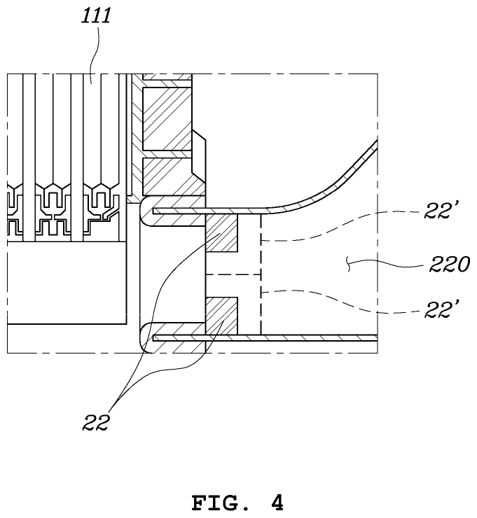

FIG. 3 is an enlarged cross-sectional view of the inlet of the vehicular battery pack shown in FIG. 2, and FIG. 4 is an enlarged cross-sectional view of the outlet of the vehicular battery pack shown in FIG. 2.

As shown in more detail in FIGS. 3 and 4, expandable foam members 21 and 22 may be respectively disposed in the inlet 210 and the outlet 220 of the vehicular battery pack 10 according to one form of the present disclosure.

The expandable foam members 21 and 22 are made of a material that expands in response to an increase in the ambient temperature (e.g. a polyurethane material containing an expandable material). In the event of a thermal runaway phenomenon in which an excessive amount of heat is generated in the battery cells 111 inside the case 100, the expandable foam members 21 and 22 may expand so as to physically block the inlet 210 and the outlet 220, thereby inhibiting or preventing external air from entering the space in the case 100, in which the battery cells 111 are disposed.

Described in detail, when thermal runaway occurs in the battery cells 111 and the internal temperature of the battery pack 10 becomes equal to or higher than the expansion initiation temperature of the expandable foam members 21 and 22, the expandable foam members may increase in volume and may physically block the inlet 210 and the outlet 220, as indicated by reference numerals 21′ and 22′. Once the inlet 210 and the outlet 220 are blocked, the internal space in the battery pack 10, in which thermal runaway occurs, becomes closed, and the introduction of external air thereinto is blocked.

Due to the expandable foam members 21′ and 22′ that have expanded, almost no external air containing oxygen necessary for combustion enters the internal space in the battery pack 10, whereby combustion inside the battery pack 10 may be suppressed. Even if combustion occurs, it is possible to suppress continuous combustion by interrupting the supply of oxygen and to block flames or harmful combustion gases from flowing out of the inlet 210 or the outlet 220.

The expandable foam members 21 and 22 may be fabricated so as to expand at a temperature at which thermal runaway is expected to occur in the battery cells 111. In addition, the sizes of the expandable foam members 21 and 22, which are disposed in the inlet 210 and the outlet 220 in a normal state, i.e. in an unexpanded state, may be appropriately set in consideration of the degree to which the expandable foam members 21 and 22 expand and the size of the opening of each of the inlet 210 and the outlet 220 so as to secure smooth flow of cooling air in the normal state of the battery cells 111.

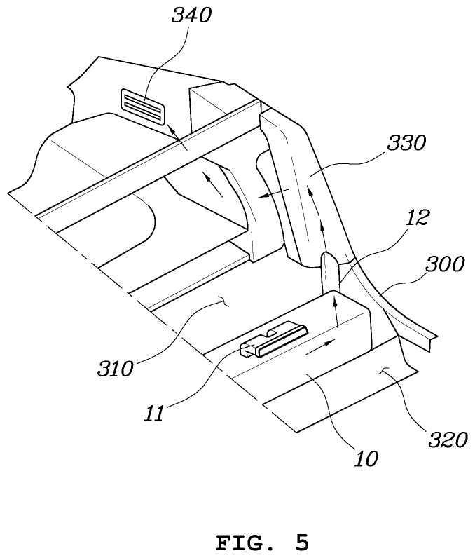

FIG. 5 is a perspective view of the structure in which the vehicular battery pack according to one form of the present disclosure is installed in the vehicle.

Referring to FIG. 5, the battery pack 10 may be disposed below a position 310 at which the second-row seat of the vehicle is disposed. The duct 11 forming the inlet may suction air from the interior of the vehicle and may supply the air to the inside of the battery pack 10. The duct 11 may be formed so as to be oriented toward a position 320 at which the legs of a passenger, sitting on the second-row seat while facing the front side of the vehicle, are placed.

The air discharged from the inside of the battery pack 10 through the outlet of the battery pack 10 by the operation of the fan 13 may pass through the air discharge structure 12, and may flow to the rear side of the vehicle through the space between the side seat 330 of the second-row seat and the second-row side surface of the vehicle body 300.

The air that has passed through the space between the side seat 330 of the second-row seat and the second-row side surface of the vehicle body 300 may be delivered to an extractor grill 340, which is formed at the rear-lateral portion of the vehicle, through the space between the body 300 of the two-row vehicle and the interior material (not shown) of the vehicle, which is disposed behind the side seat 330. The extractor grill 340 is a structure disposed in a through-hole formed in the vehicle body 300, and may serve to discharge the air, delivered thereto through the space between the body 300 of the two-row vehicle and the interior material (not shown) of the vehicle, to the outside of the vehicle.

As is apparent from the above description, according to a vehicular battery pack and a vehicle including the same according to various forms of the present disclosure, when the temperature of battery cells mounted in the battery pack abnormally increases, expandable foam members mounted in an inlet and/or an outlet, through which air is introduced into the battery pack, may expand and may interrupt the flow of air, thereby reducing or minimizing the introduction of oxygen into the battery pack, thus minimizing or preventing combustion inside the battery pack. As a result, it is possible to improve the safety of the vehicle and to provide a sufficient amount of time for occupants to escape from the vehicle in the event of combustion.

In addition, even if combustion occurs in the battery pack, the expanded foam members may suppress continuous combustion by interrupting the supply of oxygen to the space in which combustion occurs, and may block flames or harmful combustion gases from being introduced into the inlet communicating with the interior of the vehicle.

However, the effects achievable through the forms are not limited to the above-mentioned effects, and other effects not mentioned herein will be clearly understood by those skilled in the art from the above description.

Although exemplary forms of the present disclosure have been disclosed for illustrative purposes, those skilled in the art will appreciate that various modifications, additions and substitutions are possible, without departing from the scope and spirit of the present disclosure.

What is claimed is:

1. A vehicular battery pack, comprising:
a case forming an internal space to accommodate a battery cell therein;
an inlet configured to introduce air into the internal space of the case;
an outlet configured to discharge air from the internal space of the case; and
an expandable foam member disposed in at least a portion of each of the inlet and the outlet,
wherein, when a temperature of the internal space becomes equal to or higher than a preset temperature, the expandable foam member is configured to expand and interrupt introduction of air through at least a portion of each of the inlet and the outlet.

2. The vehicular battery pack of claim 1, wherein the inlet is implemented in a form of a duct that is open in a direction for introducing air.

3. The vehicular battery pack of claim 2, wherein the duct is configured to introduce air from an interior of a vehicle to the internal space of the case.

4. The vehicular battery pack of claim 1, wherein the outlet is implemented in a form of a connection pipe connecting the internal space to a component provided outside the case.

5. The vehicular battery pack of claim 1, further comprising:
a fan connected to the outlet and configured to suction air from the outlet.

6. The vehicular battery pack of claim 5, wherein the fan is configured to discharge the suctioned air to an air discharge structure connected to another ventilation structure of a vehicle.

7. A vehicle, comprising:
a battery pack installed below a seat provided in an interior of the vehicle,
wherein the battery pack comprises:
a case having an internal space to accommodate a battery cell therein;
an inlet configured to introduce air into the internal space of the case;
an outlet configured to discharge air from the internal space of the case; and
an expandable foam member disposed in at least a portion of each of the inlet and the outlet, and
wherein:
the inlet is configured to introduce air from the interior of the vehicle to the internal space of the case, and
air discharged through the outlet flows along a side surface of the vehicle through another structure of the vehicle and is discharged to an outside of the vehicle.

8. The vehicle of claim 7, wherein the inlet is implemented in a form of a duct that is open toward the interior of the vehicle and configured to introduce air from the interior of the vehicle to the internal space of the case.

9. The vehicle of claim 8, wherein the duct is open in a direction oriented toward legs of an occupant sitting on the seat of the vehicle.

10. The vehicle of claim 7, wherein the battery pack further comprises a fan connected to the outlet and configured to suction air from the outlet.

11. The vehicle of claim 7, further comprising:
an interior material disposed on a side surface of the vehicle; and
an extractor grill disposed at a rear-lateral portion of a body of the vehicle,
wherein air discharged from the outlet is delivered to the extractor grill through a space between the interior material and the body of the vehicle and is discharged to an outside of the vehicle.
